(19) United States
(12) Patent Application Publication
(10) Pub. No.: US 2025/0091307 A1
(43) Pub. Date: Mar. 20, 2025

(54) Inflatable Structure and Method

(71) Applicant: North Sails Group LLC, Bridgeport, CT (US)

(72) Inventors: Richard James Huntley Lott, Westport, CT (US); Christopher Gabriel Williams, Milford, CT (US); Paul Travor Hayden, Gosport Hampshire (GB); David Little, Corte Madera, CA (US)

(21) Appl. No.: 18/966,203

(22) Filed: Dec. 3, 2024

Related U.S. Application Data
(63) Continuation-in-part of application No. PCT/IB2023/055713, filed on Jun. 2, 2023.
(60) Provisional application No. 63/348,567, filed on Jun. 3, 2022.

(51) Int. Cl. B29D 22/02; B29C 65/48; B29C 65/50; B29L 22/02; B63H 8/12

(52) U.S. Cl. CPC B29D 22/02; B29C 65/4835; B29C 65/5014; B29L 2022/02; B63H 8/12

(57) ABSTRACT

An inflatable structure (300) made from a composite material, wherein the inflatable structure is manufactured from at least two formed material sheets (315) that are cut out of the composite material according to a predefined cut-out structure (320), and wherein the formed material sheets are glued together at respective joins (330) of the formed material sheets via a respective double-sided adhesive tape (340).

### CROSS REFERENCE TO RELATED APPLICATIONS

This application is a continuation-in-part of International Application No. PCT/IB2023/055713, filed on 2023 Jun. 2, which claims the benefit of U.S. provisional application 63/348,567, filed on 2022 Jun. 3.

### BACKGROUND

The invention relates to an inflatable structure made from a composite material. Furthermore, the invention relates to a wind wing comprising the inflatable structure and to a method for manufacturing the inflatable structure, in particular for manufacturing an inflatable structure for a wind-related sport and/or a static structure.

Inflatable structures are well-known in the art. Depending on the area of usage, different materials for providing such inflatable structures are popular. The present invention relates to lightweight inflatable structures that are particularly suited for wind-related sports, such as for example wind winging, kiting or a similar land based activity, but could equally be applied to static structures such as temporary buildings or tents as the low weight makes lifting and transporting easier and more cost effective.

Wind winging is a wind-related sport, usually a water sport, where a user holds a wind wing to catch air and generate lift. This serves to propel a user who is riding on a device such as a surfboard, a hydrofoil surfboard, or any other sliding or rolling device.

It is well-known to construct an inflatable structure made from a woven material such as dacron (woven polyester). Woven materials are made as rolled good and then laid out on a cutting table to be cut into several parts. These parts are then stitched together to form the inflatable structure, such as a tubular leading edge of a wind wing.

Other materials are also known in the art. US 2006/192055 A1 describes a bladderless inflatable kite usable to propel humans, wherein the kite foregoes some or all conventional bladder structure. The kite structure is formed of a material that comprises a laminated mix of carbon and polymer filaments into a laminate structure, wherein unidirectional prepreg tapes of in-line plasma treated fibers are spread to mono-filament level films and bonded with UV absorbing titanium resin.

It is an object of the invention to provide an improved inflatable structure, in particular an inflatable structure with a reduced mass and/or an improved stiffness.

### SUMMARY

The invention relates to an inflatable structure (300) made from a composite material, wherein the inflatable structure is manufactured from at least two formed material sheets (315) that are cut out of the composite material according to a predefined cut-out structure (320), and wherein the formed material sheets are glued together at respective joins (330) of the formed material sheets via a respective double-sided adhesive tape (340).

### DETAILED DESCRIPTION

According to a first aspect of the invention, an inflatable structure according to claim 1 is provided.

The inflatable structure is made from a composite material as given in the following. The composite material for manufacturing the inflatable structure, in particular for manufacturing a wind wing, comprises a plurality of layers with at least one layer of fibers that are arranged in parallel, wherein each layer of fibers is impregnated with a resin, in particular a thermosetting resin, and exposed to a prepreg process in which each layer of fibers is respectively pressed under a predetermined pressure, and wherein the plurality of layers is stacked and consolidated by a curing of the material under heat and/or pressure.

The composite material allows an object made of this composite material to be significantly lighter and stiffer than the respective object made of well-established material through the use of non-woven material which is inherently stiffer for a similar weight, due to the fibers being kept straight as opposed to woven material which shows bent fibers.

The composite material shows a plurality of layers, wherein at least one layer of unidirectional fibers is exposed to a prepreg process and afterwards combined with at least one further layer of the plurality of layers in order to be stacked and consolidated by a curing of the material. Such a manufacturing process allows the use of different layers with different advantageous characteristics. Different fiber materials, different types of resins, different fiber orientations, different fiber weights and/or different layer designs may be combined by the curing of the plurality of fibers. Typical fiber weights of the fibers of a respective layer of fibers will lead to a layer weight in the range of 5-50 grams per square meter.

The fibers of the at least one layer of fibers that are arranged in parallel are preferably made of carbon, polyester, aramid, Dyneema and/or ultra-high-molecular-weight polyethylene (UHMWPE). The fibers of one layer may also combine fibers of different materials.

For arranging fibers in parallel, a spread between two adjacent fibers is preferably held constant along the respective fiber. Differences of the spread between two fibers, such as between two fibers of different materials, may lead to advantageous characteristics of the respective composite material. In particular, a density of the composite material can be predefined by defining the spread between two fibers, which may lead to tuned strength and weight characteristics. The width of the spread between two fibers and the density of fibers in the spread will ultimately contribute to the size and strength of the provided composite material.

The resin used for the composite material, in particular the thermosetting resin, preferably comprises polyesters, polyurethanes, acrylics and/or epoxies. These resins are known for their use in prepreg processes. Resin contents will typically be in the range of 20 to 60 percent of the total areal weight of the layer. Details about the prepreg process and the curing process are well-known in the art and therefore not described in the following.

The curing of the plurality of layers can be provided on a flat table and/or on a 3D mold. Using a 3D mold can advantageously adapt the structure of the composite material to a future application due to an improved geometry of the composite material. Using a mold can particularly improve an automation of the respective manufacturing process. Typical cure conditions will require elevated temperatures of 80° C. to 120° C. and pressures of 14 psi, or 1 atm if using vacuum bag, to significantly higher values with a press or autoclave.

The composite material furthermore allows an advantageous automation of the manufacturing process by increasing a reliability and/or repeatability of the assembly process while decreasing a manual dexterity needed for the assembly process.

In the following, embodiments of the composite material will be described.

In a preferred embodiment, the composite material comprises at least two layers of fibers that are arranged in parallel, wherein the at least two layers of fibers are arranged such that there is a non-vanishing angle between the respective fibers of at least two different layers of fibers. Using a non-parallel orientation for fibers of different layers of fibers can provide an improved structure and strength to the respective composite material. Such an additional layer of fibers can consist of different fibers with different fiber material, a different weight of fibers, a different length of fibers, at least one continuous fiber, a different spread between two fibers and/or a different density compared to the first layer of fibers of the at least two layers of fibers. In a variant of this embodiment, the plurality of layers of the composite material only comprises the at least two layers of fibers according to this embodiment. In a further variant, the plurality of layers of the composite material comprises further layers, such as at least one laminate film, a woven layer, a film layer or the like. Typical examples of a laminate film include PET, BOPET, BOPP, TPU, PEN and/or others. The laminate film may also have been treated on one or both sides to support an adhesion to other layers. A typical thickness of such a laminate film could be in a range between 0.25 mm and 2 mm. In an alternative embodiment, the composite material comprises at least two layers of fibers wherein the fibers of both layers are all unidirectional. It shall be understood that any number of layers, in particular any number of layers of fibers, can be used to form the plurality of layers. Such layers of fibers can be provided at any parallel or non-parallel orientation in order to provide a predefined characteristic, such as a predefined strength, density, weight, flexibility, width or the like.

In a further preferred embodiment, the composite material comprises at least one layer of laminate film that is arranged to form an outer surface of the plurality of layers, wherein the at least one layer of laminate film is also consolidated with the further layers by the curing of the composite material. The laminate film can advantageously prevent abrasion, avoid sticking to itself and/or increase durability of the composite material. This is particularly valuable when producing the material as a rolled good. The curing of the composite material of this embodiment leads to a laminated composite material. In a particularly advantageous embodiment, at least two layers of laminate film are arranged to form an outer surface of the plurality of layers. Preferably the at least two layers are arranged on opposed sides of the outer surface of the plurality of layers. Thereby a durability of the composite material is particularly supported.

An alternative embodiment of the composite material consists of the number of layers with no laminate material.

Similar materials are known as cuben fiber materials which consist of a high-performance non-woven composite material used in high-strength, low-weight applications. It is usually constructed from a thin sheet of ultra-high-molecular-weight polyethylene (UHMWPE, Dyneema) laminated between two sheets of polyester. The cuben fiber material can exist in many embodiments. It can consist of any number of layers with any number of fibers, fiber densities or fiber spacings. The respective layer of fibers can also exist in any number of parallel and/or non-parallel angles relative to each other. The material can be sandwiched with a laminate material on one side, on both sides or without laminate material at all. The at least one layer of fibers can also be formed by the cuben fiber material.

Preferably, all layers of the plurality of layers of the composite material show essentially a same size. Thereby, a durable structure and strength of the composite material can be further supported.

In a further embodiment the composite material is provided as rolled good. Providing a rolled good can simplify a manufacturing of a respective object with the rolled good. It can be transported easily, and it may give agility, reproducibility and scalability to the production process. In an alternative embodiment, the composite material is provided as a number of single sheets. In a further alternative embodiment, the layers of fibers within the composite material are provided in arcs or segmented arcs. This can lead to a particularly well controllable strength profile of the respectively manufactured product. Such arcs or segmented arcs may be provided by discretely controlling a direction of respective fibers within at least one layer of fibers. Such a material can be produced with or without a laminate film. Furthermore, such a material can be produced by a curing on a table, i.e. by using a 2D profile, and/or by a curing in a 3D mold, i.e. by using a 3D profile. A 3D mold can also be used to provide the composite material as a 3Di material, known within the field of sail production.

According the first aspect of the invention, the inflatable structure made from the composite material is provided.

The inflatable structure according to the first aspect shows the same advantages as the composite material since it is made of the composite material. In particular, the inflatable structure can provide a high degree of stiffness for a similar weight compared to well-known inflatable structures made of woven material.

In the following, embodiments of the inflatable structure according to the first aspect of the invention will be described.

In a preferred embodiment, the inflatable structure is made from a laminated composite material, i.e. the composite material with at least one layer of laminate film. Thereby, a particularly durable inflatable structure can be provided.

According to the first aspect of the invention, the inflatable structure is manufactured from at least two formed material sheets that are cut out of the composite material according to a predefined cut-out structure, wherein the formed material sheets are glued together at respective joins of the formed material sheets. Using the composite material can advantageously reduce the number of formed material sheets needed for manufacturing the inflatable structure due to the relatively high stiffness of the respective formed material sheets. Gluing together respective joins can furthermore reduce a material thickness at the joins within the final product, i.e. within the inflatable structure, compared to a woven join which is usually used for arranging different material sheets at each other. Formed material sheets are formed by cutting them out according to the cut-out structure. The cut-out structure can by provided by a respective stencil. The cutting of the respective formed material sheets is preferably provided automatically by using the predefined cut-out structure.

In a preferred variant of the aforementioned embodiment, the joins of the formed material sheets are glued together via a respective thermosetting adhesive bonding. Such a thermosetting adhesive bonding allows a curing of the joins and thereby a thin, durable and reliable join for the inflatable structure. In addition, the thermosetting adhesive bonding is required to take high loads, particularly in creep, in the skin of the inflated structure. Typical inflation pressures can be in a range between 5 and 20 psi. Preferably, the thermosetting adhesive is UV resistant. Thereby, a long durability even under challenging environmental conditions, such as weather conditions, for the composite material can be provided.

According to the first aspect of the invention, the joins of the formed material sheets are glued together via a respective double-sided adhesive tape. Such an adhesive tape can simplify a production process, in particular an automated production process. By using a protective foil on at least one side of the respective double-sided adhesive tape, the adhesive tape can be positioned precisely on a first formed material sheet and afterwards the protective foil can be removed when a predefined position of a second formed material sheet relative to the first formed material sheet is reached, which means that the join can be provided by simply pressing the two formed material sheets with the double-sided adhesive tape in between together. The double-sided adhesive tape can be a pressure-sensitive adhesive tape and/or a temperature-sensitive adhesive tape. Preferably, the joins are provided by a plurality of respective double-sided adhesive tapes, such as 2 or 3 adhesive tapes as it is shown in the embodiment related to FIG. 10. Preferably, a respective adhesive tape is arranged such that it is elongated into a direction of the join.

In a preferred variant of the aforementioned embodiment, the double-sided adhesive tapes that are in contact with a respective formed material sheet are arranged on the same side of the formed material sheet. By providing the double-sided adhesive tapes on one side of the formed material sheet, all joins of this formed material sheet can be provided by a single pressing against this formed material sheet. Furthermore, such a structure of adhesive tapes can lead to particularly thin joins as it will be described later in this application, e.g. in the course of the description that is related to FIG. 6. Furthermore, the adhesive tapes of this preferred variant can be related to at least two different joints between formed material sheets. Providing the adhesive tapes of different joints on the same side of the respective formed material sheet can also reduce a peeling of the joints by wind forces along a defined direction, as it is shown with respect to FIG. 6.

In a further embodiment of the inflatable structure, an additional adhesive tape is arranged along at least one join between two formed material sheets in order to make the join airtight. The additional adhesive tape can provide a reliably airtight join. This is particularly advantages for a leading edge of the inflatable structure, i.e. the part of the inflatable structure that provides a first contact with air during motion. The additional adhesive tape shows preferably just one adhesive side in order to provide one non-adhesive side that is oriented away from the inflatable structure. The other side can be supported for example by a TPU film layer. The additional adhesive tape comprises preferably a known pressure sensitive adhesive (PSA). In a variant of this embodiment, the additional adhesive tape is arranged along each join between formed material sheets in order to make each join airtight. Thereby, the additional adhesive tape forms an anti-peel-strip since it forms an additional physical barrier that protects the adhesive tape, in particular the double-sided adhesive tape, within the respective join against environmental forces, such as wind or the like. The additional adhesive tape can be arranged at an outer surface of the respective join with respect to the inflatable structure or at an inner surface of the respective join with respect to the inflatable structure. At the inner surface, the additional adhesive tape can physically protect the double-sided adhesive tape against internal pressure and thereby support a bladderless structure of the inflatable structure.

In a further embodiment of the inflatable structure, the inflatable structure is made of at least two different composite materials. Using different composite materials can lead to an advantageous combination of different characteristics of the composite material for the inflatable structure. In an example, a central region of the inflatable structure is made of a stiffer composite material than a surrounding region. In a related example, the inflatable structure is a leading edge of a wind wing and the composite material in the center of the leading edge is stiffer than the composite material that is used for the at least one formed material sheet that is used in an area nearer to a wing tip of the leading edge.

In a particularly preferred embodiment, the inflatable structure is a kite, a wind wing, a strut of a wind wing and/or a leading edge of a wind wing. These objects need to be lightweight and preferably stiff against wind pressure. Therefore, the kite, the wind wing, the strut and/or the leading edge according to this embodiment are particularly advantageous in view of the lightweight and stiff composite material they are made of. Furthermore, these objects can be formed particularly aerodynamic in view of the glue used to glue together the formed material sheets at respective joins. Preferably, UV resistant glue is used in order to provide a durable inflatable structure.

Preferably, a valve is used to provide the inflatable object. The valve allows an inflation of the inflatable object. Such a valve can be a back pressure valve, a hose valve or any other suitable valve that is known by a person skilled in the art.

In a preferred embodiment, the inflatable structure is manufactured from at least 3 formed material sheets, preferably from at least 5 formed material sheets. In a variant of this embodiment, the number of formed material sheets used for the inflatable structure is between 3 and 6 formed material sheets. More than two formed material sheets allow a more complex design of the inflatable structure and/or the use of different materials, in particular composite materials, to provide different characteristics at different regions of the inflatable object. In a further variant of this embodiment, the inflatable structure comprises an upper and a lower part respectively comprising a number of formed material sheets. In this variant, the upper and lower part can be manufactured separately and afterwards both parts are glued together. Thereby, preferably an even number of formed material sheets is used. Examples for different numbers of formed material sheets used for the inflatable object are shown with in FIGS. 3 and 5.

According to a second aspect of the invention, a wind wing comprising an inflatable structure according to the first aspect of the invention is provided, wherein the wind wing is preferably bladderless.

The wind wing according to the second aspect shares all advantages with the inflatable structure according to the first aspect since it comprises said inflatable structure.

A wind wing has to face challenging environmental conditions and frequent contact with water. It is particularly advantageous to use the composite material under such challenging conditions. The composite material can be very light and particularly stiff, which are both advantageous characteristics for a wind wing.

The wind wing preferably comprises a leading edge, one or more struts and a canopy. These parts are bound together by an adhesive and/or sewn together. Using air-tight joins between different parts of the wind wing and/or between different formed material sheets can enable a bladderless structure of the inflatable structure and/or of the wind wing. Such a bladderless structure further reduces the weight of the wind wing.

In the following, embodiments of the wind wing according to the second aspect of the invention will be described.

The inflatable structure does preferably form the leading edge of the wind wing. Alternatively or additionally, the inflatable structure can be formed by a strut of the wind wing.

In a preferred embodiment, the composite material used for the wind wing is laminated. The at least one used laminate film enables an advantageous durability under wet conditions such as the conditions that are typically present for a wind wing.

In a further preferred embodiment of the wind wing according to the second aspect of the invention, the canopy of the wind wing is made from the composite material. Using the composite material for the canopy is particularly advantageous in view of the stiffness of the canopy. In a preferred variant of this embodiment, the wind wing and/or the canopy of the wind wing is made from a laminated composite material. By using the laminated composite material, the wind wing is better protected against water. The canopy of this embodiment is preferably cured within a 2D mold or a 3D mold. Using the 3D mold can lead to 3Di material for the canopy that is very durable even if the wind wing is exposed to strong winds and/or strong streams or waves. U.S. Pat. No. 7,479,200 B2 discloses a method for producing a 3Di canopy showing the skilled person how the canopy of this example can be produced. A discretely shaped fiber layout molded in three dimensions for optimized strength and weight characteristics of the wind wing can lead to the 3Di canopy which can be sewn and/or adhered between two struts and/or the leading edge of the wind wing in order to produce the airfoil shape of the wind wing.

Using a 3D mold for constructing the canopy of the wind wing can advantageously support a desired sailing shape of the wind wing. This might ensure that the wind wing takes an optimal sailing structure during use. It might also ensure a reliability and repeatability of the structure and of the respective manufacturing process and might also support an automation of this process.

In a further preferred embodiment, the inflatable structure is attached to a further structure of the wind wing via a T-join, in particular via a woven T-join. In a preferred variant of this embodiment, the further structure is a further inflatable structure, such as a strut of the wind wing. A T-join can provide a universal shape and can thus be used for different objects that comprise an inflatable structure. A woven T-join is less stiff than the composite material and therefore conforms to a shape of an inserted structure, such as the inflatable structure.

According to a further aspect of the invention, a static structure, such as a temporary building and/or a tent, comprising an inflatable structure according to the first aspect of the invention is provided, wherein the static structure is preferably bladderless.

The static structure according to the further aspect shares all advantages with the inflatable structure according to the first aspect since it comprises said inflatable structure.

A static structure may face frequent contact with water. It is particularly advantageous to use the composite material in order to ensure a certain durability despite the frequent contact with water. The composite material can be very light and particularly stiff, which are both advantageous characteristics for a static structure, such as a temporary building and/or a tent.

In a preferred embodiment of the static structure according to the further aspect of the invention, the static structure further comprises a T-join for arranging a further structure at the inflatable structure of the static structure. In this embodiment, the T-join advantageously forms a rather universal connection between different parts of the static structure, such as between different inflatable structures of the static structure.

According to a third aspect of the invention, a method for manufacturing an inflatable structure according to the first aspect of the invention, in particular for manufacturing an inflatable structure for a wind-related sport, such as a wind wing according to the second aspect of the invention, and/or a static structure is provided. The method comprising the steps of
providing a composite material;
cutting out at least two formed material sheets from the provided composite material according to a predefined cut-out structure; and
gluing together the formed material sheets at respective joins of the formed material sheets via a respective double-sided adhesive tape.

The method according to the third aspect of the invention shares the advantages of the inflatable structure according to the first aspect of the invention since it leads to this inflatable structure.

The method is particularly advantageous because of the use of the composite material in combination with the gluing of respective joins of the formed material sheets. These steps of the method enable the production of a very robust and durable inflatable structure which can be designed very stiff and lightweight, depending on the used layers of fibers of the composite material.

The manufacturing of the composite material is a process of its own and comprises several steps as it is obvious for somebody skilled in the art in view of the composite material. The manufacturing of the composite material at least comprises a production of at least one layer of fibers, a prepreg process of this at least one layer of fibers and afterwards a stacking and consolidation of the provided plurality of layers by the curing process. In a variant, these steps are complemented by a lamination process before the curing of the plurality of layers is provided. The curing of the plurality of layers may be provided with a heat of more than 200° F., in particular of more than 250° F., preferably around 300° F. The curing of the plurality of layers may be provided with a pressure of less than −15 psi, in particular of less than −20 psi, preferably around −25 psi.

In the following, embodiments of the method according to the third aspect of the invention will be described.

In a preferred embodiment of the method, the gluing of the formed material sheets comprises the steps of
providing an upper material sheet of the at least two formed material sheets with a perimeter of the double-sided adhesive tape;
placing the upper material sheet onto a lower material sheet of the at least two formed material sheets;
folding the lower material sheet over the upper material sheet where the adhesive is placed; and
applying heat and/or pressure to the at least two formed materials to consolidate and cure the adhesive.

This gluing process advantageously allows a gluing of the joins on a flat surface. Furthermore, the presented gluing process can be repeated precisely and it can be automated easily.

The adhesive is preferably of a type that cross links or forms a permanent bond once activated, such as a thermosetting adhesive. Such a permanent bond shows an advantageous durability since it does not creep under pressure.

Preferably, each lower material is folded with an overlap of more than 10 mm, preferably around 20 mm, to form an overlap join, such as a 20 mm overlap join.

In a preferred variant of the described gluing process, the heat is applied on a flat surface by means of a heated press, a heater and/or an autoclave. In this variant, the process is particularly easy to be automated and to be repeated precisely. An additional benefit of this gluing process is that the same flat heating and consolidation equipment can be used for many different product types and product sizes.

In a further variant of the described gluing process, at least one additional adhesive tape is arranged along at least one join between two formed material sheets in order to make the join airtight. The additional adhesive tape can comprise a typical pressure sensitive adhesive as it widely known in similar technical fields.

In a further preferred variant of the described gluing process within the method according to the third aspect of the invention, a temperature to consolidate and cure the adhesive is at least 90° C., preferably at least 110° C., and a pressure to consolidate and cure the adhesive is at least 10 psi, preferably at least 20 psi. Such temperatures and pressures support a reliable join between two formed material sheets. Furthermore, a reliable curing of a thermosetting adhesive can be provided with such a gluing process.

Different inflatable structures according to the first aspect might be produced according to the method according to the third aspect of the invention and still be arranged together as a wind wing or a kite or the like by sewing several parts together. In a particularly advantageous embodiment, several structures, such as inflatable structures are glued together to form a wind wing, a kite or the like.

It shall be understood that the inflatable structure according to the first aspect of the invention, the wind wing according to the second aspect of the invention and the method for manufacturing an inflatable structure according to the third aspect of the invention have similar or identical embodiments.

These and other aspects of the invention will be apparent from and elucidated with reference to the embodiments described hereinafter.

### BRIEF DESCRIPTION OF THE DRAWINGS

In the following drawings:

FIG. 1 shows a first embodiment of a composite material;

FIG. 2 shows a second embodiment of the composite material;

FIG. 3 shows a first embodiment of an inflatable structure, namely a leading edge, according to a first aspect of the invention;

FIG. 4 shows a predefined cut-out structure for the inflatable structure according to the first aspect of the invention;

FIG. 5 shows a second embodiment of the inflatable structure, namely a strut, according to the first aspect of the invention;

FIG. 6 shows a detailed view of a join between two formed material sheets for an embodiment of the inflatable structure according to the first aspect of the invention;

FIG. 7 shows an embodiment of a wind wing according to a second aspect of the invention;

FIG. 8 shows the inflatable structure of the wind wing within the embodiment shown in FIG. 7;

FIG. 9 shows a schematical view of a join, in particular a T-join, between two inflatable structures of the wind wing shown in FIG. 7;

FIG. 10 shows a detailed view of a join between two inflatable structures of the wind wing shown in FIG. 7;

FIG. 11 shows a first embodiment of a method according to a third aspect of the invention; and

FIG. 12 shows a second embodiment of the method according to the third aspect of the invention.

### DETAILED DESCRIPTION OF THE PREFERRED EMBODIMENTS

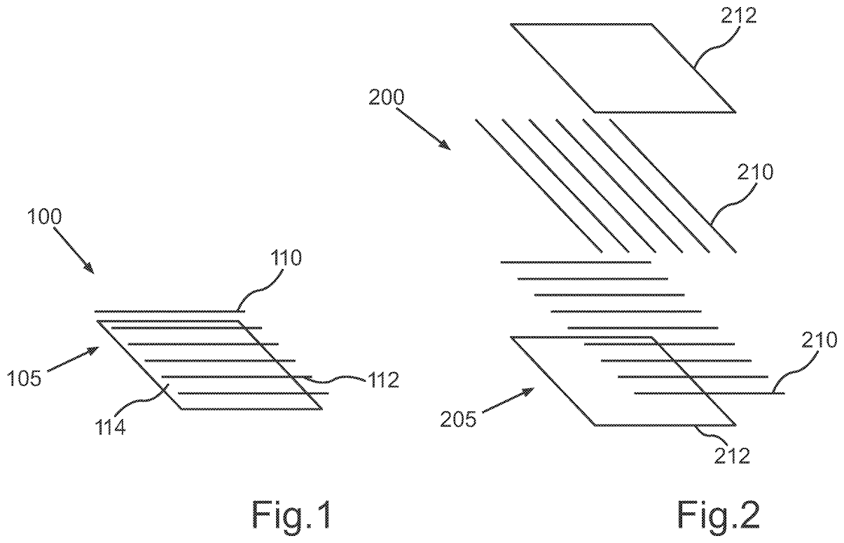

FIG. 1 shows a first embodiment of a composite material 100.

The composite material 100 is configured for manufacturing an inflatable structure, in particular for manufacturing a wind wing. For that reason, it comprises a plurality of layers 105 with at least one layer of fibers 110 that are arranged in parallel. Between the fibers 112 there is the spread 114 that is predetermined during a production of the layer of fibers 110. The used material of the fibers and the used spread of the fibers defines the characteristics, such as the density, the weight and/or the stiffness of the layer of fibers 110. The layer of fibers 110 is impregnated with a resin, in particular a thermosetting resin, and exposed to a prepreg process in which each layer of fibers is respectively pressed under a predetermined pressure. After this prepreg process, the plurality of layers 105 is stacked and consolidated by a curing of the material under heat and/or pressure.

The layers of the plurality of layers are shown in FIG. 1 and FIG. 2 separately in order to illustrate the different layers of the plurality of layers. It shall be understood that the composite material 100 and the composite material 200 of FIG. 2 both form a single flat and/or 3D material after the curing process.

The fiber material for the at least one layer of fibers that are arranged in parallel is preferably made of at least one of the following materials: carbon, polyester, aramid, Dyneema and/or UHMWPE. The fibers of one layer may also combine fibers of different fiber materials.

For arranging fibers in parallel, the spread between two adjacent fibers is preferably held constant along the respective fiber. The width of the spread between two fibers and the density of fibers in the spread will ultimately contribute to the size and strength of the provided composite material.

The resin used for the composite material, in particular the thermosetting resin, preferably comprises polyesters, polyurethanes, acrylics and/or epoxies. Details about the prepreg process und the curing process are well-known in the art and therefore not described in the following.

FIG. 2 shows a second embodiment of the composite material 200.

The composite material 200 comprises two layers of fibers 210, 210′ that are arranged in parallel, wherein the at least two layers of fibers are arranged such that there is a non-vanishing angle, namely an angle of 90°, between the respective fibers of the two different layers of fibers 210, 210′. UHMWPE fibers are used for both illustrated layers of fibers 210, 210′. These fibers are impregnated with a polyurethane resin, which is a thermosetting resin.

The outer surface of the opposite sides of the two layers of fibers 210, 210′ is laminated by using a respective polyester film layer 212, 212′ and/or a PET film. With such a laminate film layer 212, 212′ on both sides, the curing process of the shown composite material 200 leads to a laminated composite material. In a not shown embodiment, just one layer of laminate film is arranged to form an outer surface of the plurality of layers. Typical examples of a laminate film include PET, BOPET, BOPP, TPU, PEN and/or others. The laminate film layer may also has been treated on one or both sides to support an adhesion to other layers. A typical thickness of such a laminate film could be in a range between 0.25 mm and 2 mm.

The different processing steps that can be used for providing the composite material 200 comprise a prepreg process of unidirectional fibers, afterwards a cross-ply process is used to arrange the different layers of fibers 210, 210′ in a non-parallel manner. The different layers can consist of different fibers, different spreads, different resins, different length of fibers or the like. After the cross-ply process, a lamination process leads to the two polyester film layers 212, 212′ and/or PET film layers that lead to a lamination of the composite material 200 after the curing of the plurality of layers 205. A final step of the production of the composite material 200 is the assembling of the composite material 200 and/or parts of the composite material 200 for further production steps. After the final curing, all layers are consolidated to a single composite material that can be further processed as shown in the following figures. Some of the aforementioned steps are not necessary to produce the composite material. As an example, the composite material does not need to be laminated as also shown in FIG. 1.

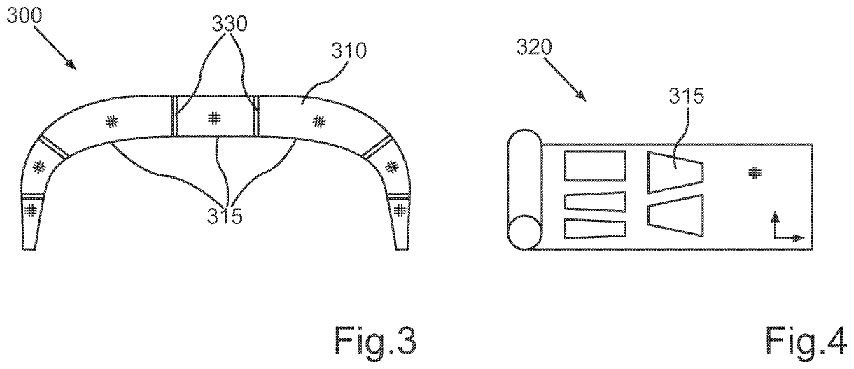

Preferably, the composite material 200 is provided as rolled good after the respective production of the composite material. The rolled good can be easily transported to cut formed material sheets out of the composite material according to a predefined cut-out structure, as shown in FIG. 4. FIG. 3 shows a top view of a first embodiment of an inflatable structure 300, namely a leading edge 310, according to a first aspect of the invention.

The inflatable structure 300 is made from the composite material 200 that is shown in FIG. 2.

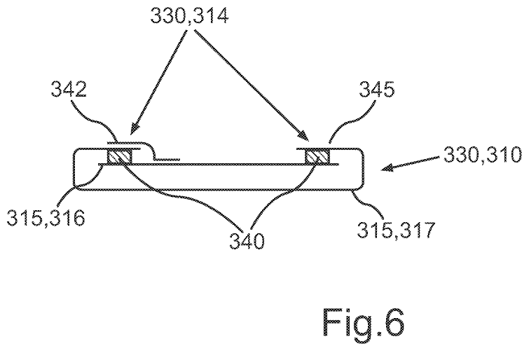

The inflatable structure 300 is manufactured from at least two formed material sheets 315 that are cut out of the composite material 200 according to a predefined cut-out structure 320 as shown in FIG. 4. In the illustrated embodiment, the inflatable structure 300 is manufactured from 14 formed material sheets 315, wherein the 7 depicted parts respectively comprise an upper material sheet and a lower material sheet, as also shown in FIG. 6, wherein just the upper material sheets are shown in FIG. 3 and the lower material sheets are arranged under the upper material sheets in the depicted top view. The formed material sheets 315 are glued together to form the inflatable structure 300. The respective joins 330 are formed via a thermosetting adhesive bonding forming a bondline between two formed material sheets 315. Preferably the thermosetting adhesive bonding is provided by using a double-sided adhesive tape, as it is described with respect to FIG. 6.

The different formed material sheets 315 shown in FIG. 3 can be made of at least two different composite materials. Different composite materials can lead to different characteristics of the inflatable structure 300 in different regions of this structure. For example, it can be advantageous that a central region of the inflatable structure 300 is stiffer than the wing tips outside of the center of the leading edge 310. Thereby, a user of the wind wing can rely on the stiffness and durability of the leading edge 310.

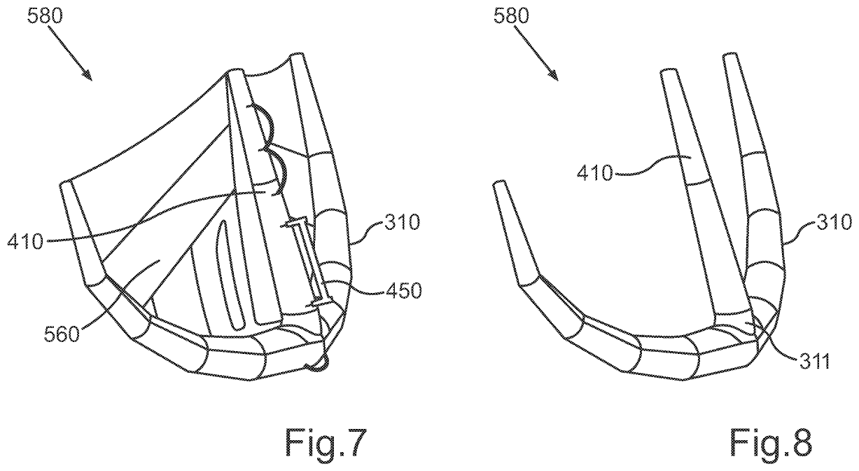

The further structure of a wind wing using the leading edge 310 is shown in FIG. 7.

FIG. 4 shows a predefined cut-out structure 320 for the inflatable structure 300 according to the first aspect of the invention.

The cut-out structure 320 is preferably stored in a memory of a cutting machine in order to provide an automated cutting process. FIG. 4 furthermore illustrates that the composite material 200 is provided as rolled good, which has to be rolled out in order to cut out the formed material sheets 315

In an alternative embodiment, the cut-out structure is printed on the composite material in order to allow a precise cutting of the formed material sheets 315 by hand or via a respective cutting machine.

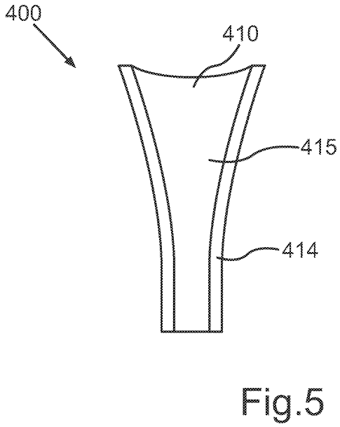

FIG. 5 shows a second embodiment of the inflatable structure 400, namely a strut 410, according to the first aspect of the invention.

The strut 410 can be combined with the leading edge 310 as described in the course of FIGS. 7 to 10. The strut 410 consists of two parts, an upper material sheet and a lower material sheet, wherein two bondlines 414 show the region of the join between both formed material sheets 415.

A wind wing can comprise one or more struts that are usually arranged at the leading edge of the wind wing. The strut is usually the place where a user of a wind wing holds the wind wing so that few formed material sheets and a large stiffness are advantageous for the strut.

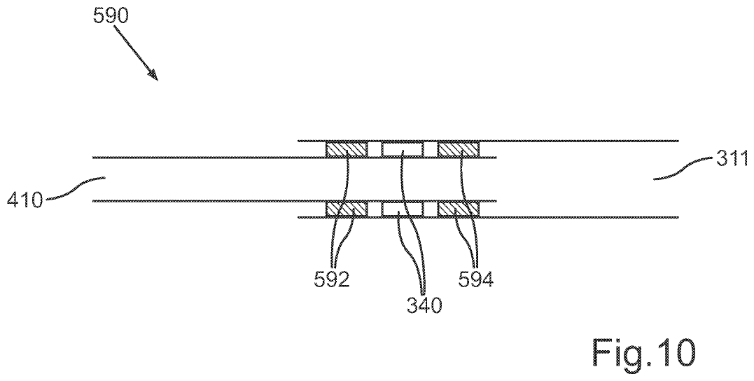

The strut may be airtight on its own or in combination with a join, such as a T-join. The strut can have an opening that is closed by attaching the strut to the T-join, preferably with an adhesive as described in FIG. 10. The strut may comprise a valve to inflate the strut.

FIG. 6 shows a detailed view of a join 330 between two formed material sheets 315 for an embodiment of the inflatable structure 300 according to the first aspect of the invention.

The depicted detailed view is a cross section of an inflatable structure 300 according to the first aspect of the invention in a not inflated state, with an upper material sheet 316 and a lower material sheet 317. Both material sheets are glued together via a respective double-sided adhesive tape 340 on every bondline 314. The double-sided adhesive tapes that are in contact with a respective formed material sheet 315 are arranged on the same side of the formed material sheet 315. This arrangement of the tapes 340 allows the structure of the upper material sheet 316 lying on the lower material sheet 317 with both tapes 340 oriented away from the lower material sheet 317 so that the lower material sheet has to be folded over the upper material sheet 316 in order to provide the join 330. This structure allows a pressure or heating of the join 330 on a flat table with simple, well-known devices such as a heated press, a heater and/or an autoclave.

In this embodiment, an additional adhesive tape 342 is arranged along at least one join between two formed material sheets in order to make the join airtight. As a further protection of the join 330, it can be regarded as an anti-peel strip. The additional adhesive tape 342 provides a protective layer for the covered double-sided adhesive tape 340. The additional tape might comprise a simple pressure sensitive adhesive (PSA) whereas the double-sided adhesive tape 340 is preferably provided with a thermosetting adhesive, such as a heat reactive adhesive. The heat reactive adhesive might react during a temperature range between 80° C. and 150° C., preferably at around 105° C. The overlap 345 of the lower material sheet 317 over the upper material sheet 316 is between 10 mm und 30 mm, preferably around 20 mm, in the depicted embodiment. In a preferred variant of this embodiment, an additional adhesive tape is arranged along each join between formed material sheets of the inflatable structure 300 in order to make each join airtight.

Such an adhesive tape 340 preferably provides an airtight join and thereby allows a bladderless structure of the respectively produced inflatable object. This can further reduce a weight of such an inflatable object.

In an inflated state, a gas, preferably air, is pressed between the lower material sheet 317 and the upper material sheet 316 in order to inflate the inflatable structure 300.

If the inflatable structure 300 is mainly oriented in a way that the join-free side of the cross section shown in FIG. 6 is exposed to wind, the structure of the joins supports a reduced exposure of said joins to wind forces.

In a further not depicted embodiment, a respective join, similar to the join shown in FIG. 6, is provided by a plurality of adhesive tapes, in particular of double-sided adhesive tapes.

FIG. 7 shows an embodiment of a wind wing 580 according to a second aspect of the invention.

The wind wing 580 combines the leading edge 310 shown in FIG. 3 with the strut 410 shown in FIG. 5.

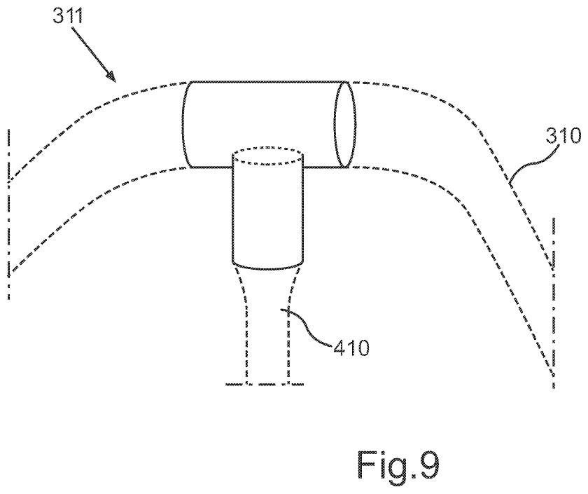

The strut 410 also shows handles 450 to allow a user a comfortable holding of the wind wing 580. The two inflatable structures, i.e. the leading edge 310 and the strut 410, are combined in a way that both inflatable structures 310, 410 need a respective not depicted valve to inflate the respective structure. The join to combine both structures, which is in the shown embodiment a T-join, is illustrated in FIG. 9.

In this embodiment, all inflatable structures comprise their own valve so that they can be inflated separately. Preferably, the valve of the leading edge 310 and the valve of the strut 410 are both arranged in the region of the T-join. Thereby, a structure of the composite material may not be disturbed by a valve or at least just disturbed in a region were the T-join is put over the composite material. In a not shown embodiment, at least two inflatable structures of the wind wing comprise a common valve to inflate the wind wing.

In the depicted embodiment, the canopy 560 of the wind wing 580 is arranged at the leading edge 310 and at the strut 410. Furthermore, the canopy 560 is made from the composite material. Therefore, the wind wing provides an advantageous stiffness and lightweight compared to known wind wings made from woven materials.

The canopy 560 is preferably cured in a 3D mold in order to provide a desired sailing shape. Such a 3D mold can also be used for other formed material sheets of the wind wing in order to provide a reliable automated curing with a constant quality.

As explained above, the illustrated wind wing 580 is preferably bladderless, i.e. can be inflated without the need of a bladder.

In other not illustrated embodiments, the inflatable structure according to the first aspect of the invention is a kite and/or the leading edge of a kite. In a further not illustrated embodiment, the inflatable structure is a combination of a leading edge and at least one strut.

The wind wing according to the second aspect of the invention can also comprise woven materials as long as at least one component, such as the leading edge and/or at least one strut, forms the inflatable structure according to the first aspect of the invention.

It should be understood that the inflatable structure according to the first aspect of the invention can also be used for other sport related structures, such as a kite. It is also clear to anyone skilled in the art that the inflatable structure according to the first aspect of the invention can also be used for a static structure, like a temporary building or a tent.

FIG. 8 shows the inflatable structures 310, 410 of the wind wing 580 within the embodiment shown in FIG. 7.

By focusing on the inflatable structures that form a frame of the wind wing, it becomes clear, that the leading edge 310 comprises a T-join 311 in which the strut 410 is inserted. This allows the use of only one valve to inflate both inflatable structures together. However, in the depicted embodiment, leading edge and strut comprise separate valves and are just hold together by the T-join

Furthermore, a curvature of the leading edge 310 is provided in the depicted embodiment by using a plurality of formed material sheets respectively glued together as explained with respect to FIGS. 3 and 6.

FIG. 9 shows a schematical view of a join, in particular the T-join 311 between two inflatable structures 310, 410 of the wind wing 580 shown in FIG. 7.

The T-join is preferably pre-made and softer, i.e. less stiff, than the composite material used for the leading edge 310. Such a softer material enables a sliding of the leading edge through the respective opening of the T-join, since the T-join 311 conforms to the shape of the leading edge 310. Furthermore, the strut 410 can be easily pushed into the respective opening of the T-join. In a preferred variant of this embodiment, the T-join is woven and/or stitched. Thereby, a rather universal T-join for different applications, such as an inflatable structure for a wind-related sport and/or for a static structure, such as temporary buildings or tents, is provided.

In a preferred variant of the depicted embodiment, the T-join also comprises at least one valve to inflate at least one inflatable structure of the wind wing. Furthermore, a handle of the wind wing can be attached to the T-join. Furthermore, a bladder-position of a bladder within the wind wing, such as within the strut, can be fixed within the T-join, if a bladder is used within the wind wing.

In the depicted embodiment, the strut 410 only becomes airtight in combination with the T-join 311, which closes an opening of the strut 410.

The T-join 311 as shown in FIG. 9 can as well lead to an attachment between an inflatable structure and a further structure within a static structure, such as a temporary building or a tent.

FIG. 10 shows a detailed view of a join 590 between the two inflatable structures 310, 410 of the wind wing 580 shown in FIG. 7.

The strut 410 is inserted into the T-join 311, which is attached to the leading edge 310 as shown in FIG. 9. In order to provide stiffness and a reliable join, a double-sided adhesive thermosetting tape 340 with a circumferential arrangement is complemented by two further pressure sensitive adhesive tapes 592, 594 that support the join 590 in order to provide an airtight join. Thus, all tapes of this join 590 are arranged on an outside surface of the strut 410. The structure of the leading edge in order to provide the T-join or to provide a circumferential structure that allows a fitting of the T-join is preferably provided by providing respective cut-out structures.

In a not shown embodiment, at least one additional adhesive tape is used to provide a further protection of the pressure sensitive tapes 592, 594 and of the double-sided adhesive thermosetting tape 340 as it is similarly used in the embodiment of FIG. 6.

Other arrangements of the adhesive tapes can also be used to form a join according to the first aspect of the invention, as long as a double-sided adhesive tape is used.

The shown arrangement allows a pressure or heating of the join 590 on a flat table with simple, well-known devices such as a heated press, a heater and/or an autoclave. Thereby, a particularly thin and airtight join 590 can be provided.

The combination of the depicted structure with the advantageous composite material can allow a particularly stiff and light characteristic of the respective inflatable structure.

In a not shown embodiment, the T-join is inserted into the strut and the tapes are on the outside surface of the T-join.

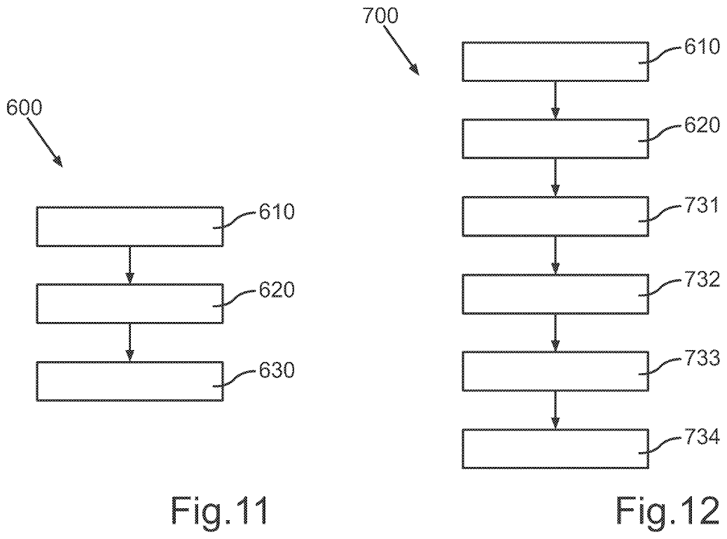

FIG. 11 shows a first embodiment of a method 600 according to a third aspect of the invention.

The method 600 is configured for manufacturing an inflatable structure according to the first aspect of the invention, in particular for manufacturing an inflatable structure for a wind-related sport, such as a wind wing according to the second aspect of the invention, and/or a static structure. The method comprising the steps as explained in the following.

A first step 610 comprises a providing of a composite material.

A next step 620 comprises a cutting out of at least two formed material sheets from the provided composite material according to a predefined cut-out structure.

A final step 630 comprises a gluing together of the formed material sheets at respective joins of the formed material sheets.

The steps 610, 620, 630 of this method 600 are performed in the presented order. Between these steps, there can be long time spans. The composite material could be provided according to step 610 but the cutting could start much later. After the cutting according to step 620, the gluing according to step 630 can also be executed later. It is possible that all steps of method 600 are executed immediately but there can also be long time intervals between two of these steps.

The steps can be provided in the form of sub steps of a respective sub process. Possible steps of a process to produce the composite material have been described above, wherein a separation between a prepreg process and a curing process has been pointed out.

FIG. 12 shows a second embodiment of the method 700 according to the third aspect of the invention.

The second embodiment of the method 700 differs from the method 600 shown in FIG. 10 that the gluing of the formed material sheets according to step 630 comprises sub steps that are explained in the following.

A first sub step 731 comprises a providing of an upper material sheet of the at least two formed material sheets with a perimeter of an adhesive, in particular an adhesive tape.

A second sub step 732 comprises a placing of the upper material sheet onto a lower material sheet of the at least two formed material sheets.

A further sub step 733 comprises a folding of the lower material sheet over the upper material sheet where the adhesive is placed.

A next sub step 734 comprises an application of heat and/or pressure to the at least two formed materials to consolidate and cure the adhesive.

The further steps 610 and 620 remain unchanged in the method 700 as illustrated in FIG. 12. Preferably, all steps are executed in the given order.

The application of heat within the sub step 734 is preferable executed on a flat surface by means of a heated press, a heater and/or an autoclave. Such devices are well known in the art. They allow an advantageous automation of the gluing process and a high degree of reproducibility.

The temperature to consolidate and cure the adhesive is at least 90° C., preferably at least 110° C., and a pressure to consolidate and cure the adhesive is at least 10 psi, preferably at least 20 psi.

The method therefore provides multiple sub-processes. Within step 610, the composite material is provided by using a prepreg process for manufactured layers of fibers and by curing all layers of the plurality of layers to get the composite material. The curing can be provided by a pressure of at least −10 psi, in particular −20 psi, preferably around −25 psi, while the heat is at least 200° F., in particular 250° F., preferably around 300° F. Such a curing process can take between 2 and 4 hours, preferably around 3 hours. Within step 620 a cutting of the formed material sheets is provided, manually, semi-automatically and/or automatically. Within the gluing process according to step 630, the sub steps 731 to 734 can be provided in order to provide reliable and flat joins for the inflatable structure.

### LIST OF REFERENCE NUMERALS

100, 200 composite material
105, 205 plurality of layers
110, 210, 210′ layer of fibers
112 fiber
114 spread
212, 212′ polyester film layer/laminate film
300, 400 inflatable structure
310 leading edge
311 T-join
314, 414 bondline
315, 415 formed material sheet
316 upper material sheet
317 lower material sheet
320 cut-out structure
330, 590 join
340 double-sided adhesive tape
342 additional adhesive tape
345 overlap
410 strut
450 handles
560 canopy
580 wind wing
592, 594 pressure sensitive adhesive tape
600, 700 method
610, 620, 630, 731, 732 steps
733, 734

1. An inflatable structure (300) manufactured from at least two formed material sheets (315) that are cut out of the composite material (100) according to a predefined cut-out structure (320),
wherein the composite material (100) is comprising a plurality of layers (105) with at least one layer of fibers (110) that are arranged in parallel, wherein each layer of fibers (110) is impregnated with a resin, in particular a thermosetting resin, and exposed to a prepreg process in which each layer of fibers (110) is respectively pressed under a predetermined pressure, and wherein the plurality of layers (105) is stacked and consolidated by a curing of the composite material (100) under heat and/or pressure,
wherein the formed material sheets (315) are glued together at respective joins (330) of the formed material sheets (315),
and wherein the joins (330) of the formed material sheets (315) are glued together via a respective double-sided adhesive tape (340).

2. The inflatable structure (300) according to claim 1, wherein double-sided adhesive tapes (340) that are in contact with a respective formed material sheet (315) are arranged on the same side of the formed material sheet (315).

3. The inflatable structure (300) according to claim 1, wherein an additional adhesive tape (342) is arranged along at least one join (330) between two formed material sheets (315) in order to make the join airtight.

4. The inflatable structure (300) according to claim 1, wherein the inflatable structure (300) is made of at least two different composite materials (100) according to claim 1.

5. The inflatable structure (300) according to claim 1, wherein the composite material (200) is comprising at least two layers of fibers (210, 210′) that are arranged in parallel, wherein the at least two layers of fibers (210, 210′) are arranged such that there is a non-vanishing angle between the respective fibers (112) of at least two different layers of fibers (210, 210′).

6. The inflatable structure (300) according to claim 1, wherein the composite material (200) is comprising at least one layer of laminate film (212) that is arranged to form an outer surface of the plurality of layers (205), wherein the at least one layer of laminate film (212) is also consolidated with the further layers by the curing of the composite material (200).

7. The inflatable structure (300) according to claim 1, wherein the inflatable structure (300) is a kite, a wind wing (580), a strut (410) of a wind wing (580) and/or a leading edge (310) of a wind wing (580).

8. The inflatable structure (300) according to claim 7, wherein the inflatable structure (300) is manufactured from at least 3 formed material sheets (315), preferably from at least 5 formed material sheets (315).

9. A wind wing (580) comprising an inflatable structure (300) according to claim 1, wherein the wind wing (580) is preferably bladderless.

10. The wind wing (580) according to claim 9, wherein a canopy (560) of the wind wing (580) is made from the composite material (100).

11. The wind wing (580) according to claim 9, wherein the inflatable structure (300) is attached to a further structure of the wind wing (580) via a T-join (311), in particular a woven T-join (311).

12. A method (600) for manufacturing an inflatable structure (300) according to claim 1, in particular for manufacturing an inflatable structure for a wind-related sport, such as a wind wing (580) according to claim 9, and/or a static structure, comprising the steps of
providing a composite material (100) according to claim 1;
cutting out at least two formed material sheets (315) from the provided composite material (100) according to a predefined cut-out structure (320); and
gluing together the formed material sheets (315) at respective joins (330) of the formed material sheets (315) via a respective double-sided adhesive tape (340).

13. The method (700) according to claim 12, wherein the gluing of the formed material sheets (315) comprises the steps of
providing an upper material sheet (316) of the at least two formed material sheets (315) with a perimeter of the double-sided adhesive tape;
placing the upper material sheet (316) onto a lower material sheet (317) of the at least two formed material sheets (315);
folding the lower material sheet (317) over the upper material sheet (316) where the adhesive tape is placed; and
applying heat and/or pressure to the at least two formed materials sheets (315) to consolidate and cure the adhesive tape.

14. The method (700) according to claim 13, wherein the heat is applied on a flat surface by means of a heated press, a heater and/or an autoclave.
